(19) United States
(12) Patent Application Publication
(10) Pub. No.: US 2002/0107849 A1
(43) Pub. Date: Aug. 8, 2002

(54) Scholarship search method and system

(76) Inventors: Matthew W. Hickey, Portland, OR (US); James H. Wolfston, West Linn, OR (US); Raymond L. Price, Portland, OR (US)

Correspondence Address: MICHAEL O. SCHEINBERG, P.O. BOX 164140, AUSTIN, TX, 78716-4140, US

(21) Appl. No.: 09/999,063

(22) Filed: Oct. 31, 2001

Related U.S. Application Data
(60) Provisional application No. 60/245,779, filed on Nov. 1, 2000.

(51) Int. Cl. G06F 7/00

(52) U.S. Cl. 707/3

(57) ABSTRACT

The present invention provides an improved scholarship searching service that includes a scholarship search server that is connected to a plurality of client computers. The server presents each client with an interface that can be branded and customized to any institution, such as a college or financial aid provider, giving the appearance that the search service is being provided by the institution. The server provides a set of scholarships based on user information and in response to the user selecting one of the one or more search options. In one preferred embodiment, the scholarship server and thus the scholarship service is provided and administered by a third-party provider, in accordance with the desired specifications of a sponsor institution. In this embodiment, a provider institution can pay the third-party provider to provide the service as a gratuity to the sponsoring institution.

This application claims priority from U.S. Provisional Patent Application No. 60/245,779, which is hereby incorporated by reference.

### TECHNICAL FIELD OF THE INVENTION

The present invention relates generally to scholarship search systems and in particular to a web-based, scholarship search system.

### BACKGROUND

With the ever-increasing costs of education, students and their parents rely more and more on scholarships including loans, grants, awards and other financial aid. Unfortunately, many scholarships—which would otherwise be available to a student—are not applied for by the student because he/she may not be aware of it. Even more problematic, some available scholarships are not awarded even though eligible students exist because such students are not aware of the scholarships and thereby cannot apply for them.

Scholarship search service engines are available in various forms including CD ROM and over the World Wide Web. Such services allow users (e.g., students) to enter their personal user data (e.g., age, sex, residence) and view scholarships that are available to them based on this data. Unfortunately, such services are difficult and costly to effectively maintain. Numerous scholarships exist, and new scholarships are continuously being created while others expire. In addition, some scholarship sponsors desire control as to how their scholarships are presented to student users in such a searching service. Moreover, numerous institutions (universities, financial institutions, etc.) would like to offer their own searching services so that they can control—among other things—how scholarships are presented. Unfortunately, it is not practicable for all such sponsors and institutions to facilitate their own searching service.

Accordingly, what is needed is an improved system and method for providing scholarship searching services.

### SUMMARY OF THE INVENTION

The present invention provides an improved scholarship searching service that includes a scholarship search server that is connected to a plurality of client computers. Each client has an interface for providing a user with access to the scholarship searching service. The scholarship server is accessible to the clients. In implementing the search service, the server acquires from a user information relating to the user. The server provides one or more search options to the user. In response to the user selecting one of the one or more search options, the server provides the user a set of scholarships, the members of the set being determined by the acquired information. In one preferred embodiment, the scholarship server and thus the scholarship service is provided and administered by a third-party provider in accordance with the desired specifications of a sponsor institution, such as a university. In this embodiment, a provider institution, such as a bank, can pay the third-party provider to provide the service as a gratuity to the sponsor institution.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows one embodiment of a scholarship search system of the present invention.

FIG. 2 shows one embodiment of a routine for implementing a scholarship search service of the present invention.

FIGS. 3A through 3M depict exemplary screen prints to be displayed to a user in a scholarship searching system of the present invention.

FIG. 4 shows an exemplary screen print of a form for enabling a sponsor institution to conveniently specify criterion for a customized scholarship search service that is provided for the institution by a third party provider.

FIG. 5 shows another embodiment of a routine for implementing a scholarship search service of the present invention.

### DETAILED DESCRIPTION

Introduction

The present invention provides a scholarship search service made available to users (e.g., students, prospective students, parents, friends) over a network such as the Internet. Such a service helps students locate scholarships that may be available to them. With the present invention, a scholarship search service may be provided and administered by a third party service provider—alone and/or on behalf of a sponsor institution (e.g., university). When provided for such an institution, it can be customized as desired by the institution.

In one embodiment, the scholarship search service is provided for a sponsor institution such as a university as a gratuity from a financial institution (e.g., a bank that processes student loans). In this scenario, the bank is deemed a “provider” institution. For example, the bank could pay the third party service provider to provide for the university a scholarship search service directed to a database of scholarships provided by the university and/or available to the university's students.

In one implementation, the service is provided to users over the Internet. When provided on behalf of a sponsor institution such as a university and when so desired, the service can have a web-site appearance that is matched to or “branded” like other sites provided by the institution.

Another aspect of the invention is that the scholarship search service could include a listing of (or link to) the provider institution (e.g., bank) that provided the scholarship search service on behalf of the university financial aid office. As a benefit to the provider bank, any available scholarships associated with the bank could preferentially “bubble” to the top of any search results generated in response to a search request by a student. In addition, the listing for the bank could include contact information and a link to the bank, and a link (e.g., “Apply Here”) that could allow the student to apply online, e.g., for a student loan from the provider bank. The application could utilize the Universal Forms Engine, described in U.S. patent application No. 09/325,533, which is hereby incorporated by reference, and so could greatly reduce the effort required to complete the application to the bank.

System Overview

The system according to a preferred embodiment of the present invention comprises a scholarship search system that identifies scholarship awards (e.g., grants, loans, awards) for which a user may be eligible. The preferred embodiment, which is operated by a third party provider, uses relational databases for storing information and communicates with students and institutions over the World Wide Web. The invention is not limited, however, to the processing of any particular type of form or to the use of any particular network or database.

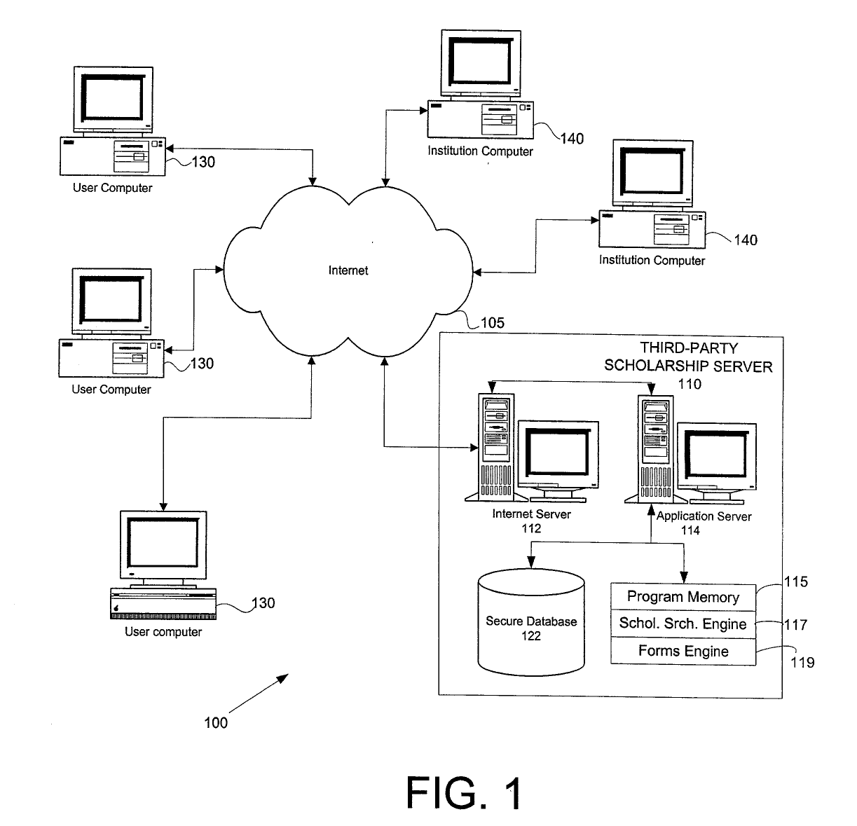

FIG. 1 shows one embodiment of a scholarship search system 100 of the present invention. System 100 includes scholarship server 110, multiple user computers 130, and multiple institution computers 140 communicatively connected to one another through the portion of the Internet 105 known as the World Wide Web (the Web). Scholarship server 110 generally includes Internet server 112 and an application server 114, which has program memory 115 for—among other things—storing and executing a scholarship search engine 117 operating in cooperation with forms engine 119. The application server 114 is also operably connected to secure database 122, which stores scholarship, scholarship search service, and student search data.

Both the Internet and Application Servers are computers, such as a Sun Solaris UltraSparc Servers, that respectively execute Web server software (for coordinating communications with visitors to a scholarship search service Web site) and a search (and possibly forms) engine for implementing a scholarship search service of the present invention. Scholarship search service information and forms transferred from a server are typically formatted in a hypertext mark-up language (HTML) and can include text, programs, graphics, video, and audio portions. The scholarship search engine program may be implemented with a common gateway interface (CGI) program specified by a form (e.g., HTML form received from a user via a search service web site) to provide a scholarship search session. The CGI program is preferably written in Perl, C, C++, Java, or another language that supports CGI. The CGI program accesses database 122, which includes information about scholarships provided for the scholarship search service. The database is preferably a relational database that is accessed using a structured query language through a database management system, such as DB2 from IBM. It should be noted, however, that the invention is not limited to a particular implementation technology. The implementation details of the invention are expected to change as computer technology evolves.

Server 110 is preferably operated by a third party scholarship search service provider and is connected to secure data storage. Multiple institution computers 140, operated by institutions such as universities and financial institutions, can communicate with the third party provider's server 110 over the Internet. In this way, sponsor institutions (institutions having their own, customizable search service provided via server 110), as well as provider institutions (institutions providing for sponsor institutions customizable search services on behalf of the sponsor institution) can conveniently access an associated search service, which is being implemented on server 110. It should be recognized that multiple search services may be simultaneously provided through search server 110. This allows each customizable service to pick from and access scholarships from a universal scholarship database, e.g., within database 122.

A typical user computer 130 comprises a personal computer, such as a Pentium-based personal computer using a Windows-based operating system and running a commercially available Web Browser, such as Netscape Navigator or Internet Explorer. In a preferred embodiment, user computers can use an older, text-based browser, because processing, such as error checking, may be performed at server, rather than at the client browser.

Although the preferred embodiment of the invention is implemented using an Internet Web site, the invention is not limited to any particular type of computer or computer network. By making the search service and even the scholarship applications available over the Web, any student with a Web browser can conveniently search for available scholarships.

Scholarship Search Routine

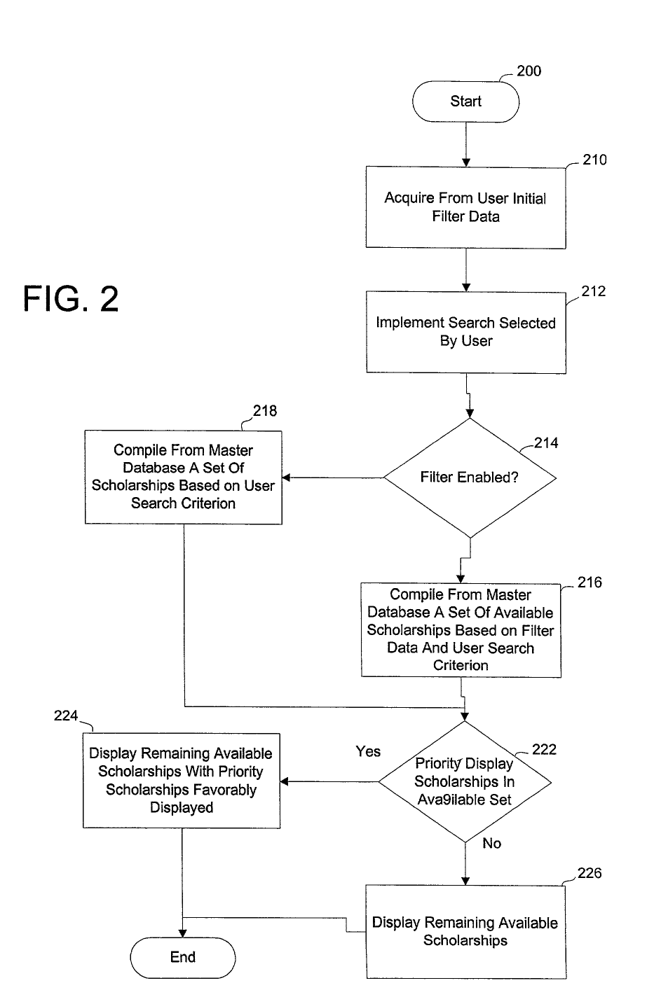

FIG. 2 shows one embodiment of a routine 200 for implementing a scholarship search engine, which is used to provide a scholarship search service of the present invention. Routine 200 is implemented by server 110 in cooperation with a user at a user computer 140. Initially at 210, initial filter information is acquired from the user. Such information could include, but is not limited to, gender age, education and residency. The information is used to filter out scholarships that would not be available to the user. Elicited filter information and filter categories can include any suitable combination of such information and categories as desired by a system designer for matching user information with scholarship criterion for the scholarships in a particular scholarship database. In one embodiment, the filter categories include General (age, sex), Residence, Employment, Academic, Miscellaneous, Organizations/Memberships, and Talent/Skill. The filter categories were selected based on the requirement criterion of the scholarships in the scholarship database. For example, Residence is used because some of the scholarships in the particular database require that a qualified applicant reside within or within a given distance from a particular geographical designation (state, county, business). Thus, in this example, appropriate geographic designations are elicited from a user through the Residence filter category.

Next, at step 212, the routine implements a particular search or display option as defined or selected by the user. In one embodiment of the present invention, several search options are made available to a user. These options include a category search, a keyword search, and a simple listing of available scholarships —with unavailable scholarships filtered out based on the initial filter information.

Next, at step 214, the routine determines whether or not the filter is enabled. If not enabled, at step 218 the routine compiles from a particular predefined database a set of scholarships meeting criterion established by the user based on the user's selected search option but without considering the filter information. Conversely, if the filter was enabled, then at step 216, the routine compiles from the database a set of available scholarships based not only on criterion specified by the user pursuant to his/her selected search option, but also, based on the initial filter information provided to the system. Thus, at this point, regardless of whether step 216 or step 218 was performed, a set of available scholarships are compiled and ready to be presented to the user.

At step 222, the routine determines whether any of the compiled scholarships are priority display scholarships, which have been designated to be prominently displayed (e.g., at the top of the list). If the compiled set includes such priority display scholarships, then at step 224, these priority display scholarships are prominently displayed to the user. On the other hand, at step 226, if no priority display scholarships were included in the set of compiled available scholarships, then the set of compiled available scholarships are presented to the user in a random fashion at step 226.

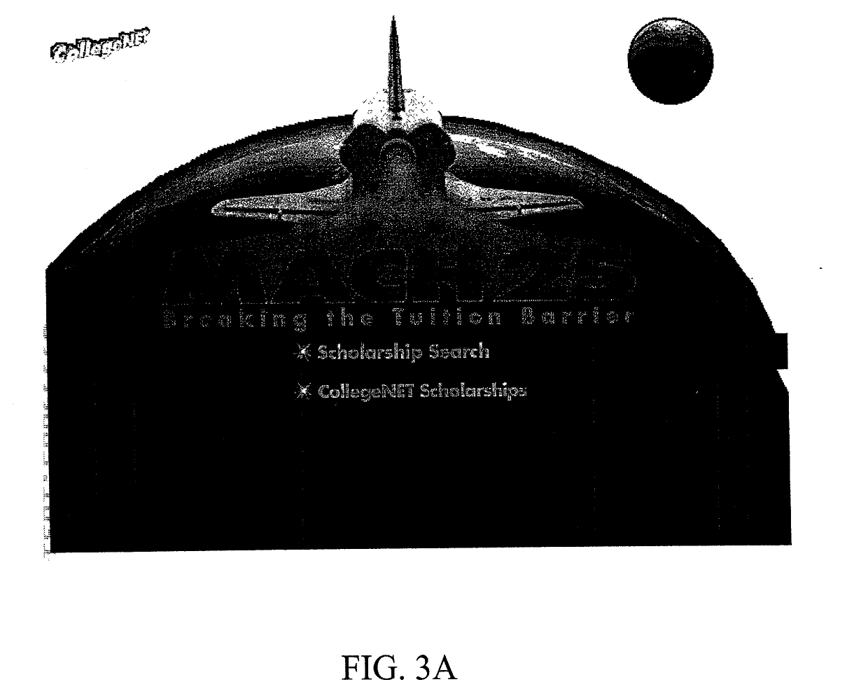

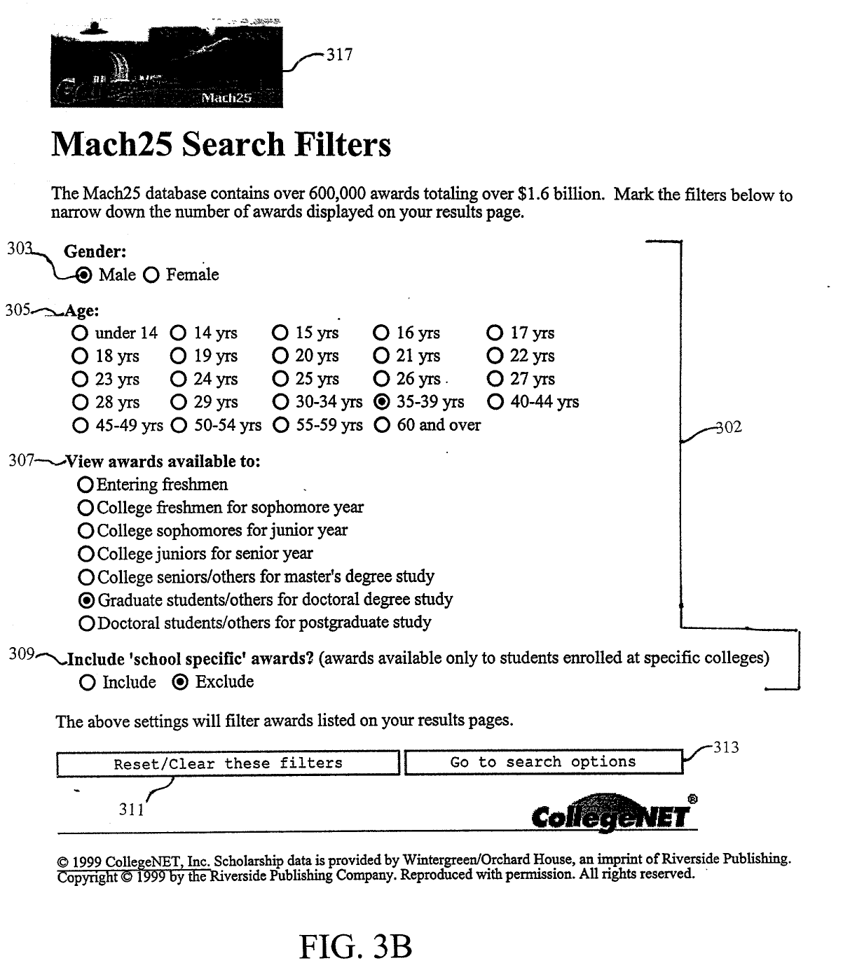

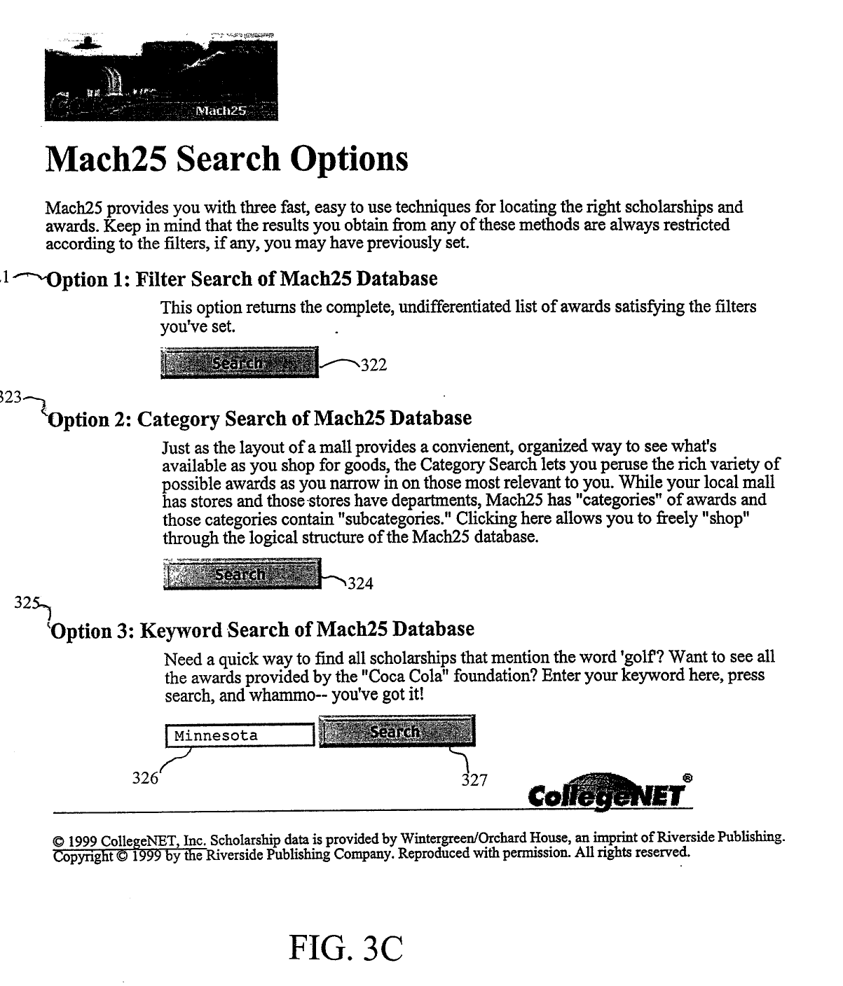

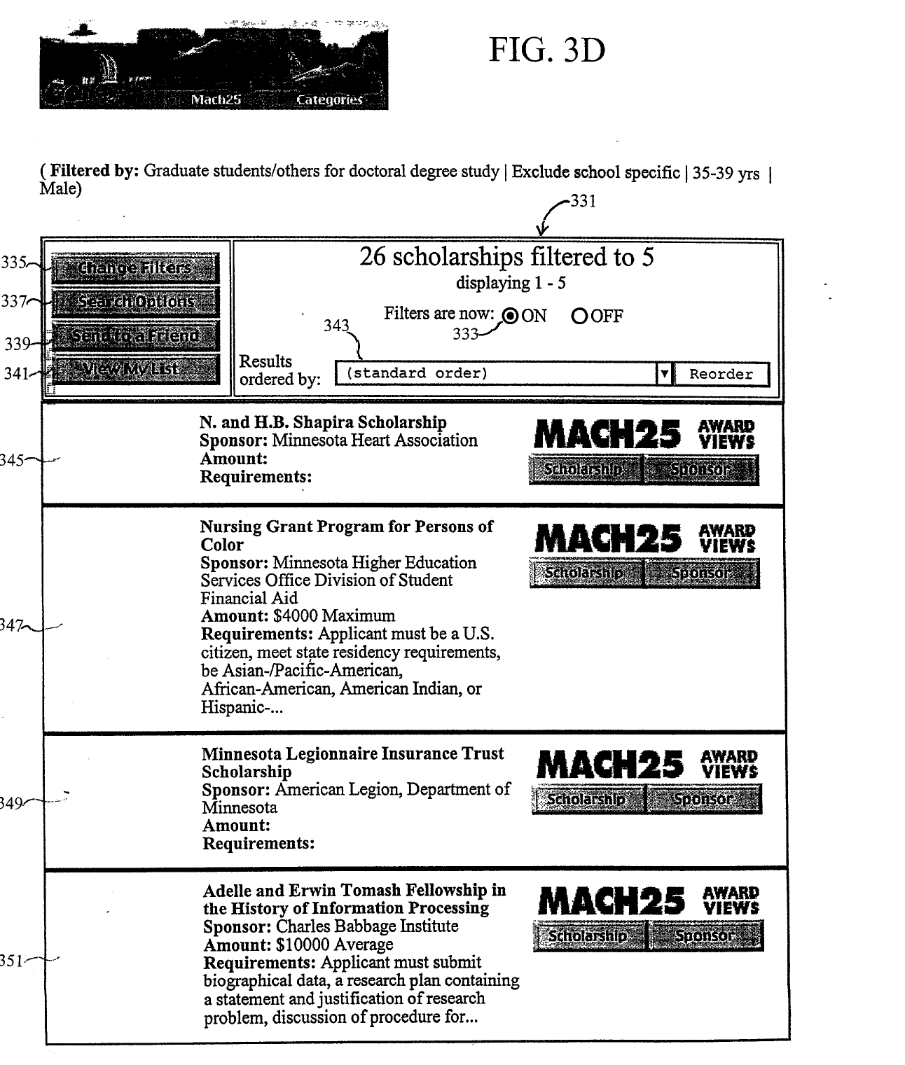

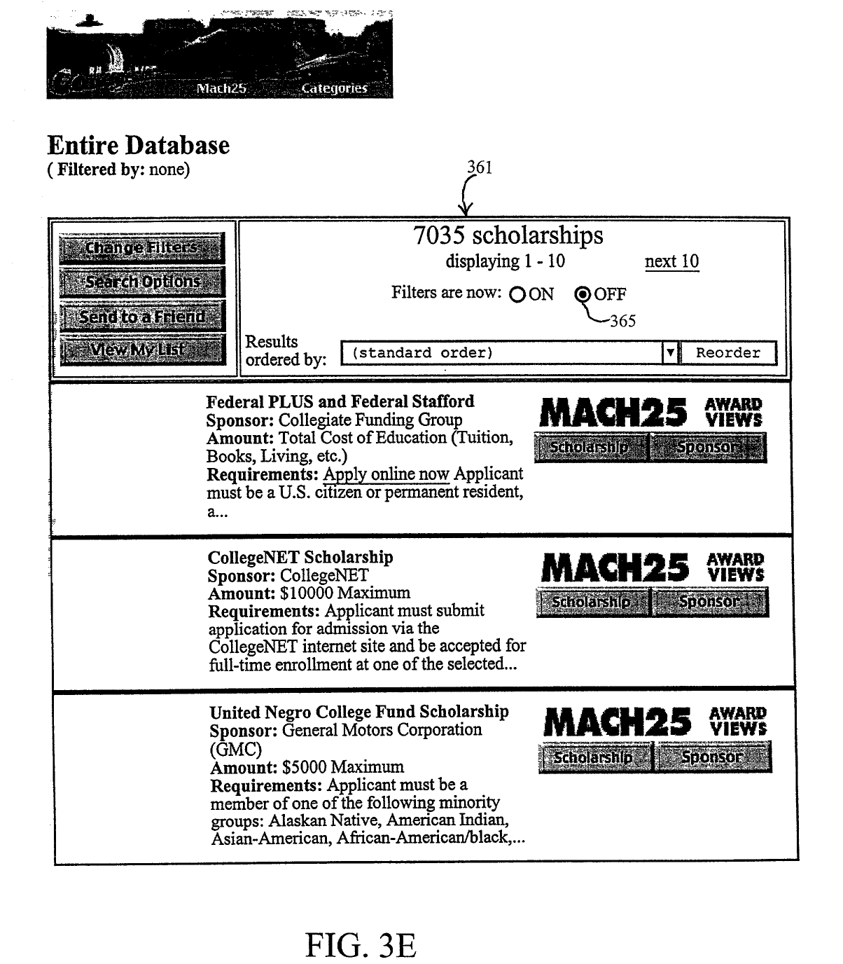

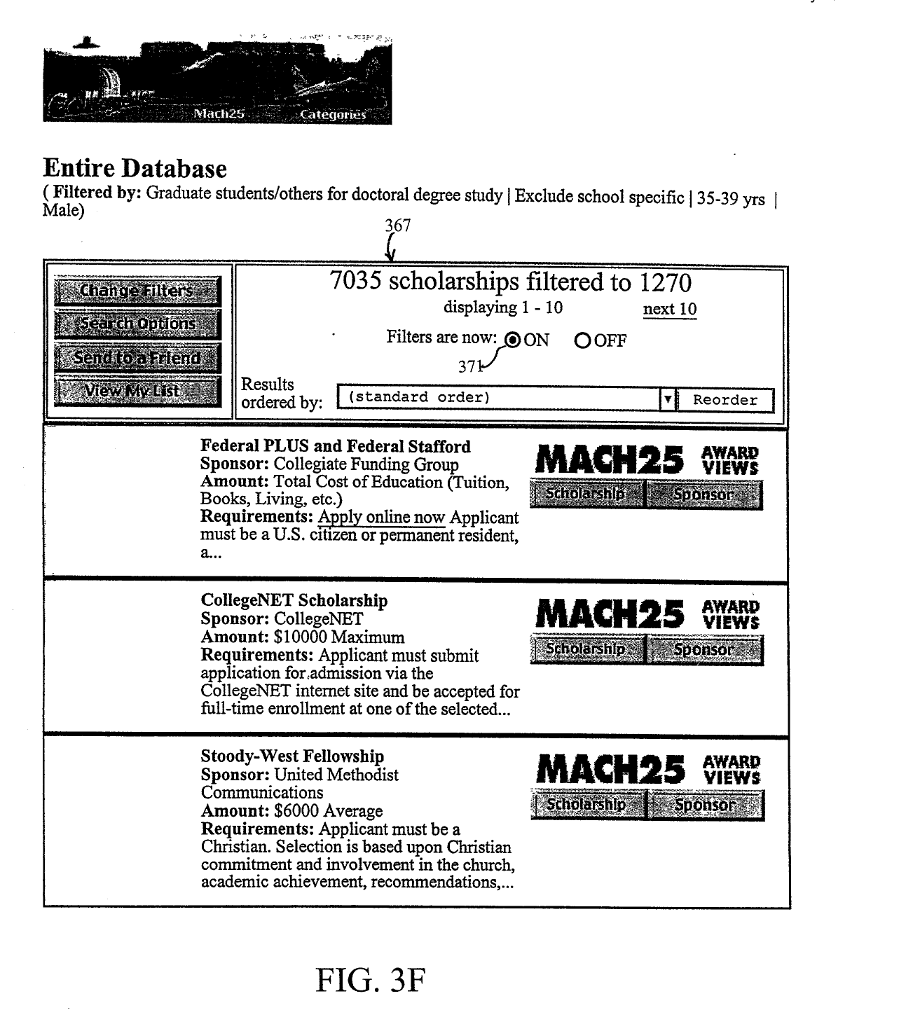

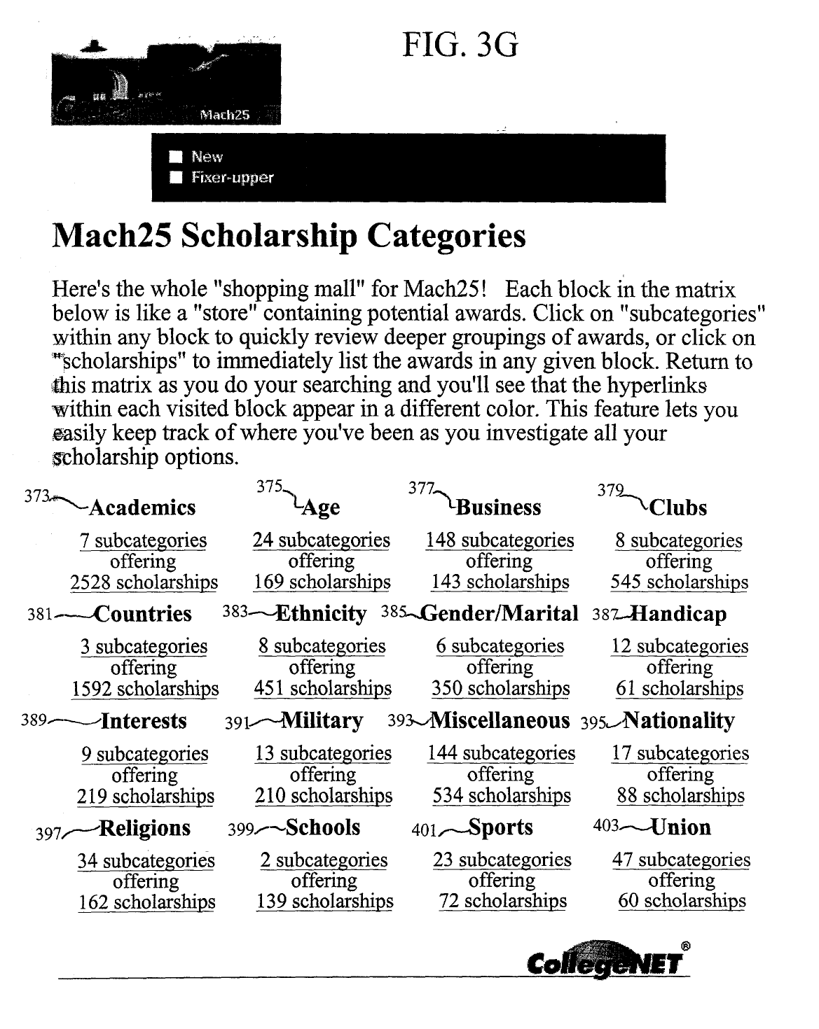

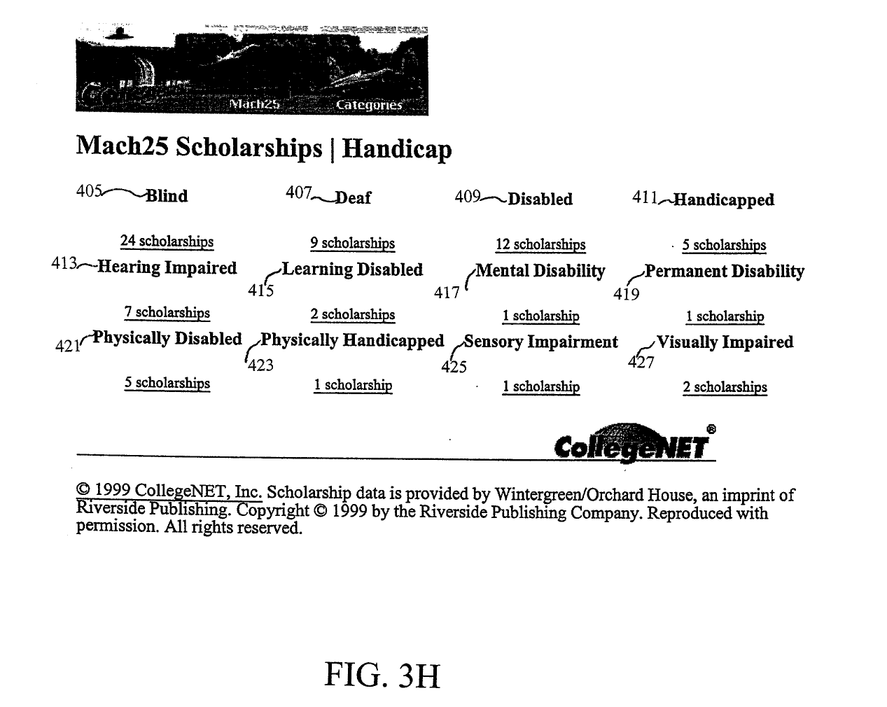

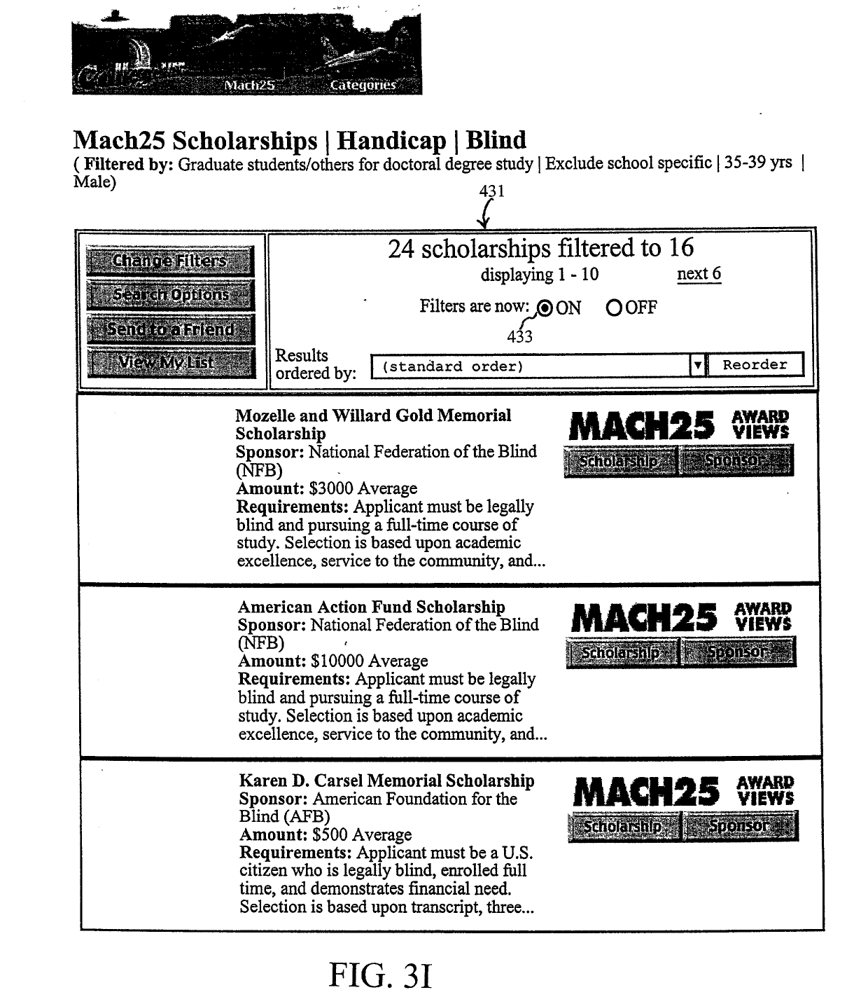

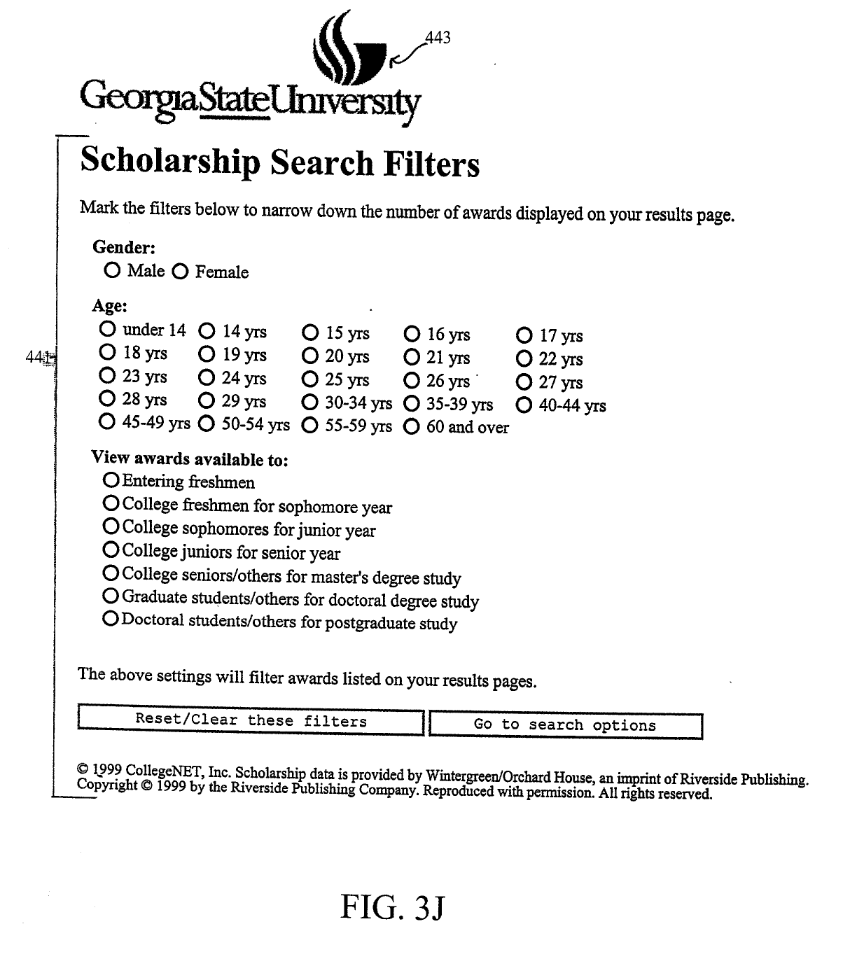

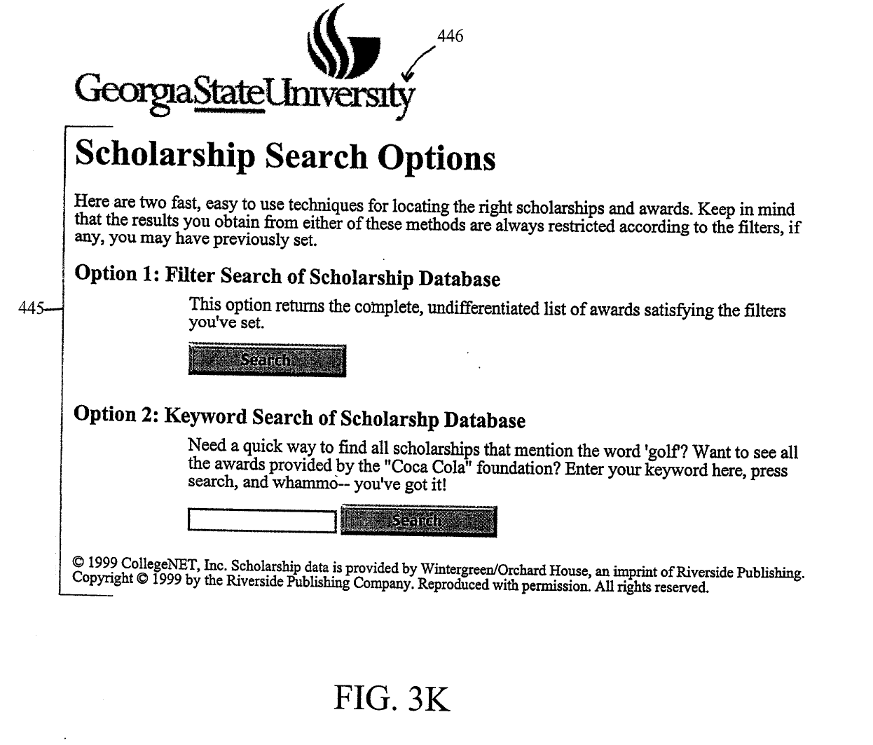

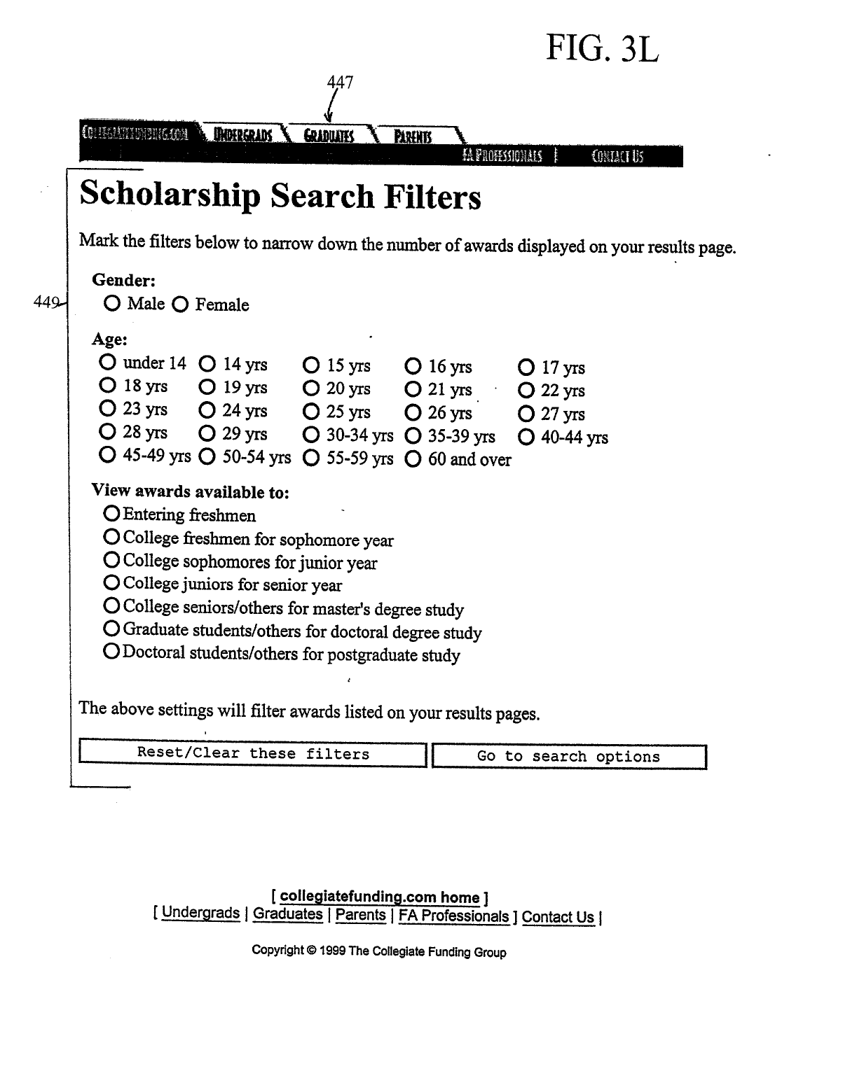

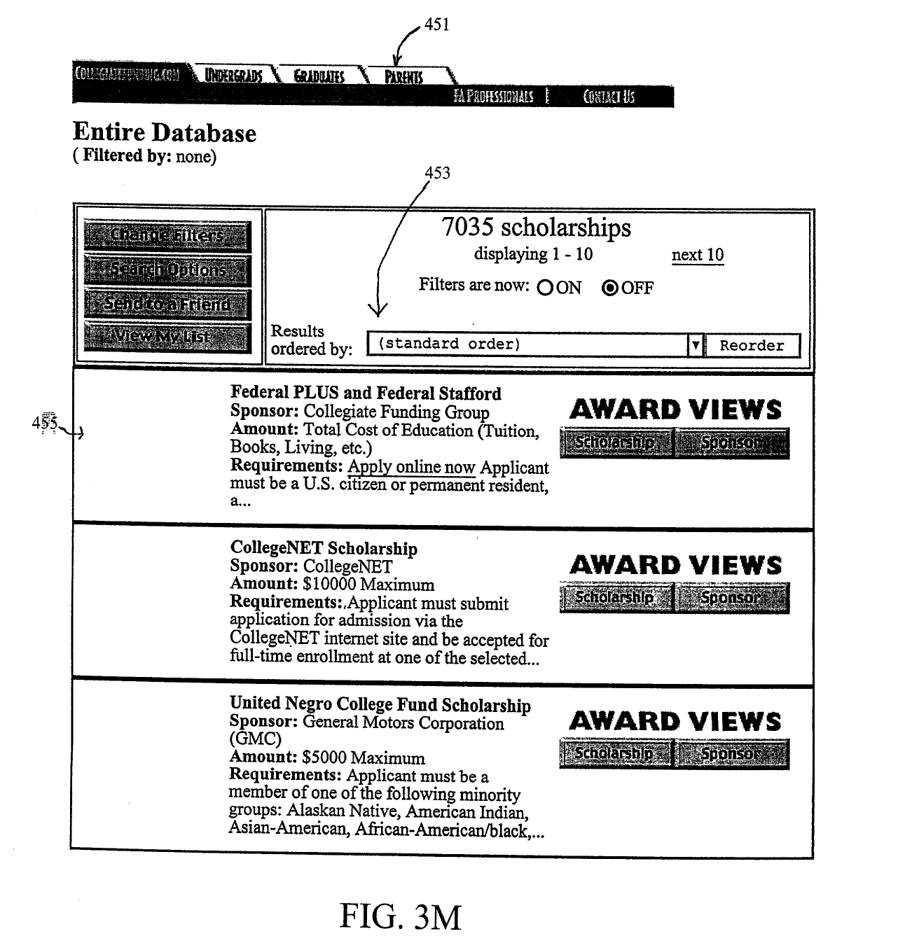

FIGS. 3A-3M show screen prints from an exemplary scholarship search service of the present invention. In this example a third-party service provider, CollegeNET (whose website may be found at www.collegenet.com), is facilitating the scholarship search service(s) via its centralized scholarship search server.

FIG. 3A shows an entry page to the CollegeNET scholarship searching services. As seen in the figure, a user may either select a scholarship search link or a CollegeNET scholarships link. In order to get to the scholarship search service, the user would select the scholarship search link.

FIG. 3B shows the screen that a user could see upon selecting the scholarship search link. This screen corresponds to a search filter screen for eliciting from a user initial filter information. Included in the screen are filter information inputs 302, reset/clear button at 311, a search option select button at 313, and a third-party provider logo (CollegeNET) at 317.

Filter inputs 302 include gender inputs 303, age inputs 305, student status buttons 307, and school specific (option) buttons 309. Thus, a student user would provide to the system this initial filter information through the various radio buttons, which implement filter input 302. Upon entering this information, a user can either reset (or clear) his/her entries at 311 or proceed to the search options page by selecting this link at 313. The system will store this initially entered filter information and possibly use it to narrow down available scholarships from the potentially available scholarship awards in the predefined scholarship database.

FIG. 3C shows a search option page, which allows the user to select a particularly desired search option. In this example, three search options are made available to the user. The first option at 321 simply allows the user to run the initially entered filter information against the main database of potentially available scholarships. That is, by selecting the search link at 322, the system will provide to the user a list of search results that are available to the user based on initially entered filter information. The second option at 323 allows the user to further narrow down the search based on categories pre-defined by the third-party system provider. By selecting button 324, the user can execute this category search. The third option at 325, allows the user to perform a keyword search on the database of potentially available scholarships.

Within field 326, the user enters one or more keywords that will be referenced against keyword indexes associated with the scholarships in the database. In the example, a user has entered the term: Minnesota in the keyword field at 326. By selecting the search button at 327, a keyword search using the term Minnesota is performed against the database of scholarships. It should be noted that the search engine implements each of these three search options without regard to the filter information. In this way, a user can view search results with the filters either disabled or enabled, as will be seen in the next screen print.

FIG. 3D shows the results from the user selecting the third, keyword option. With the filters being turned on at button 333, the search compiled a total of five available scholarships from 26 that matched the keyword (Minnesota) entered by the user.

At 335-341, the user can modify the displayed results by changing the filters at 335, changing the search option at 337, sending the results to a friend at 339, or viewing the results via a list at 341. With this screen, a user can also select how the results are to be ordered. As shown at 343, in this example, the user has left the default standard order option to be implemented. The particular scholarship search results are displayed at 345 through 351. For each displayed result, various information, including the title, the sponsor, the award amount, and the requirements for receiving the scholarship are presented to the user.

For example, with the first result, the title of the scholarship is Nursing Grant Program for Persons of Color. Its sponsor is the Minnesota Higher Education Services Office; the award amount is $4,000 maximum, and it includes various requirement criteria including that the applicant must be a U.S. citizen, meet state residency requirements, and meet a particular ethnicity requirement. Also included with each displayed result are scholarship and sponsor buttons. The scholarship button allows the user to view additional information on the scholarship including an application to fill out and submit to the scholarship's sponsor. The sponsor button may be a link to a sponsor of the scholarship and can include any information as desired by the sponsor.

FIG. 3E shows the results of a search when the first option (simply based on initial filters) is selected. As shown at 361, 7,035 potentially available scholarships are displayed to the user with the filters being turned off at 365. The same basic search and display options are provided in this screen, as with the other available search options, and thus, will not be addressed in detail.

FIG. 3F shows the results at 367 after the first search option is selected, but with the filters turned on at 371. With the filters turned on, a total of 1,270 potentially available scholarships are displayed from an overall total of 7,035 possible scholarships. These 1,270 scholarships match the filter data as initially entered by the user.

FIG. 3G shows the screen that would be displayed if the user would select the second search option, which is the category search. In this screen, various categories for narrowing down presented scholarships are presented to the user. In this embodiment, the categories include Academics at 373, Age at 375, Business at 377, Clubs at 379, Countries at 381, Ethnicity at 383, Gender/Marital at 385, Handicap at 387, Interest at 389, Military at 391, Miscellaneous at 393, Nationality at 395, Religions at 397, Schools at 399, Sports at 401 and Union at 403. Included with each category listing is an indication of how many scholarships are available for a category, as well as the number of associated subcategories. By selecting a category with a hypertext link, the user is directed to a page that corresponds to that category.

FIG. 3H shows the page that appears when a user selects the handicap category. As shown in this screen, the various subcategories are presented at 405-427. These categories include blind at 405, deaf at 407, disabled at 409, handicapped at 411, hearing impaired at 413, learning disabled at 415, mental disability at 417, permanent disability at 419, physically disabled at 421, physically handicapped at 423, sensory impairment at 425, and visually impaired at 427. It may be observed that several of these subcategories appear to be redundant with respect to each other.

For example, blind at 405 would appear to be the same as visually impaired at 427, and both of these subcategories would seem to be subsumed by sensory impaired at 425, however, each of these subcategories are separately enumerated in order to correspond to the textual requirements as defined by a particular scholarship sponsor. That is, the search service should be capable of matching input user data against requirement criterion as defined by the scholarship sponsor. Rather than interpreting or translating these criterion, in many cases it is more efficient, as well as effective, to simply work from the criterion as specified by the sponsor.

FIG. 3I shows the screen that would appear in this example if the user selects the blind subcategory at 427. As shown in this figure, with the filters turned on at 433, 24 potentially available scholarships are displayed at 431.

Other aspects of the scholarship search service in this example will now be presented. FIG. 3J shows the same filter data screen as previously presented above except branded to conform with the look and feel of a university website. In this case, the university institution is Georgia State University. The screen includes a Georgia State University logo at 433, which is part of other web screens presented by this institution. This screen would be arrived at by a user from an entry screen that is part of a Georgia State University website (e.g. financial aid office) scholarship search web page. This could correspond to a separate scholarship search service, which is being provided for a sponsor institution (i.e., Georgia State University) but implemented and administered by a third-party provider via its scholarship search server.

In this way, the sponsor institution can provide to its students a scholarship search service that conforms to desired characteristics of the institution. The institution can provide such a service without having to expend resources and time to create and maintain it. They simply instruct the third-party service provider as to how and what type of data (e.g. scholarships) are to be presented. For example, while this filter screen is substantively the same as the previously presented screen, the institution, if desired, could redefine the type of filter data being elicited. For example, it may not wish to distinguish between males and females, and it may wish to only make available to its students scholarships being sponsored by the university itself.

FIG. 3K shows a scholarship search options page, which is branded to appear to this Georgia State University sponsor institution.

FIG. 3L shows another example of a scholarship search filter page, which has been branded to conform to that of a provider institution, which is providing the scholarship search service to itself through a third party provider. In this case, the institution is a financial institution named College Funding; its logo appears at 447. This screen depicts how a scholarship search service implemented and maintained by the third-party service provider and provided for college funding may appear.

FIG. 3M shows search results for a filter search that has been executed on this College Funding scholarship search service with the filters being turned off, all 7,035 scholarships appear to the user. It is worth noting that with this example, the institution chose for its search service to include all of the possible scholarships stored within the third-party service provider database.

A feature of some embodiments of the present invention, which is illustrated in this screen, relates to the system's ability to display priority scholarship search results. The first result that is displayed in this example at 355 is a scholarship entitled Federal PLUS and Federal Stafford. As can be seen, this scholarship is sponsored by College Funding Group, which is the provider and sponsor institution for this scholarship service. It can be seen that College Funding can choose to have scholarships that it sponsors presented in a more favorable manner than the other scholarships. In this case, their scholarships are presented at the top of the list.

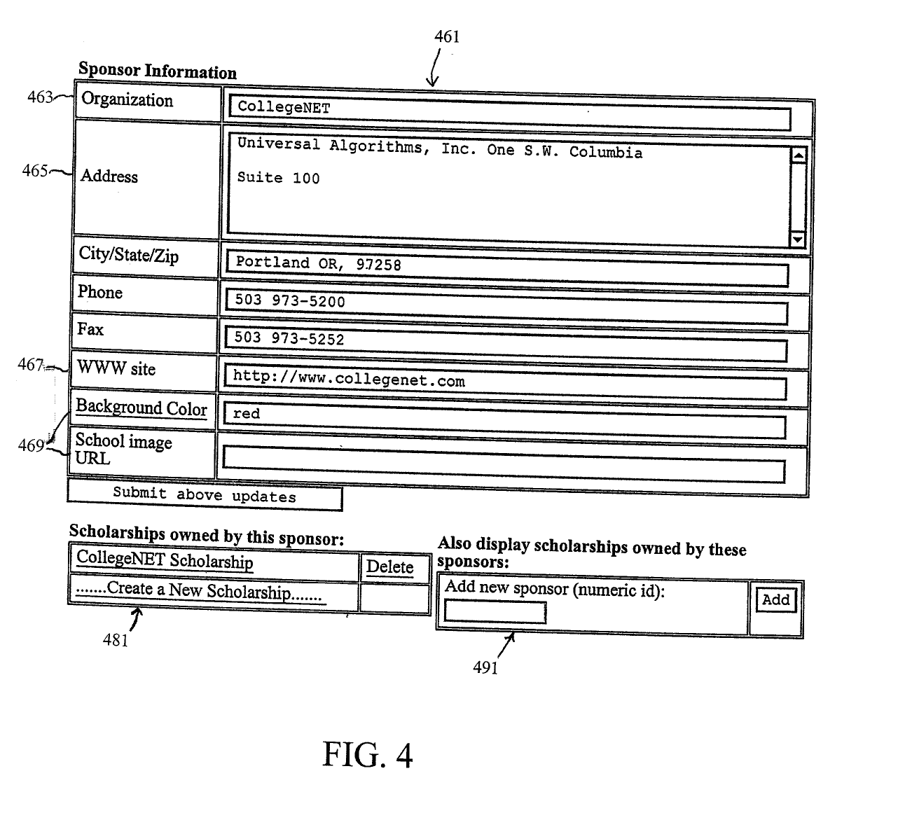

FIG. 4 shows a sponsor search service update screen, which illustrates another aspect of the present invention. This sponsor search service screen includes a sponsor information section 461, a sponsor's scholarships section 481, and an others scholarship section 491. The sponsor information section 461 includes an organization name field 463, an address field and other information field 465, a website URL field 467, and a display field 469, which includes information relating to the display of the sponsor's scholarship search service screens. The sponsor's scholarship field 481 includes one or more scholarships that may be owned by the sponsor and now provided through its scholarship search service.

Conversely, the other scholarships 491 includes a list of scholarships the sponsor wishes to provide through its search service that it does not sponsor. The sponsor screen allows a sponsor to conveniently modify not only the look and feel of its scholarship search service screens, but also, its content including scholarships it wishes to make available to its student users. In turn, a third-party provider, which is facilitating the search service for the sponsor institution, automatically receives the update information and incorporates it into a database, which causes the sponsor institution's search service to be appropriately modified.

Alternative Embodiments

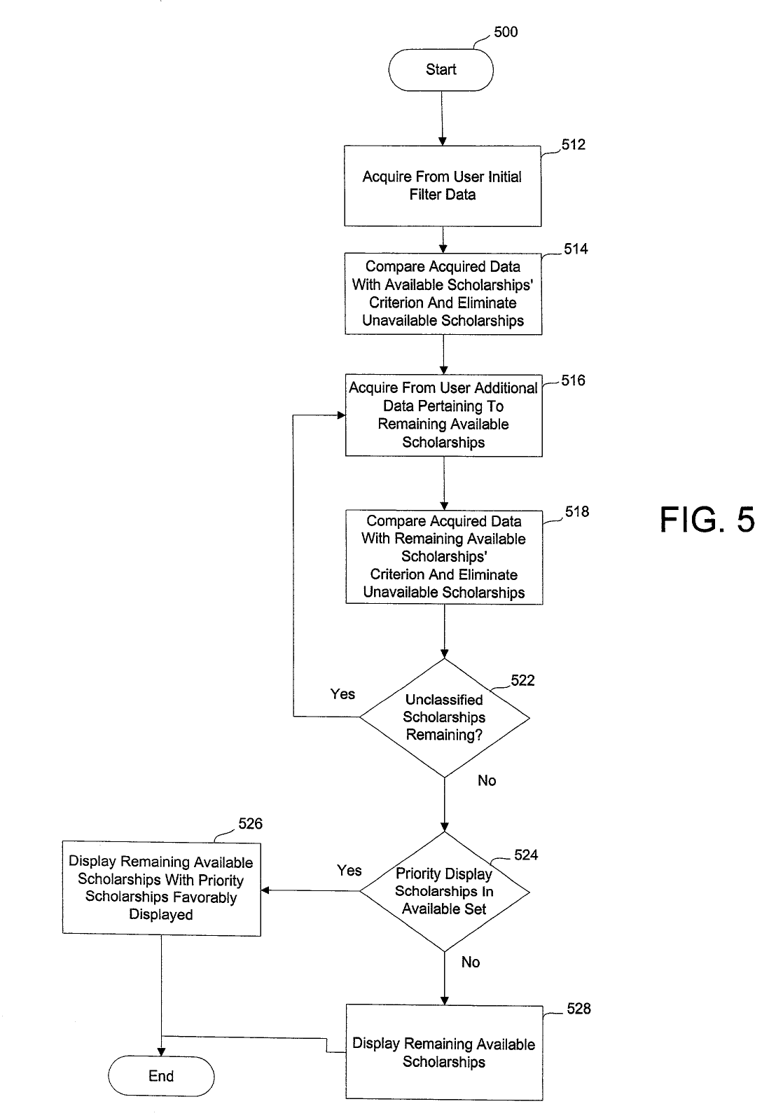

FIG. 5 shows an alternative embodiment of a routine 500 for implementing a scholarship search service of the present invention. In this routine, the search engine dynamically elicits the filter information from a user in response to previously provided information. In this way, extensive filter information may be derived from a user without having to present him/her with an excessive number of questions. At step 512, initial filter information is acquired from the user. Next, at step 514, the initially acquired data is compared with criterion from potentially available scholarships in order to eliminate those scholarships that would not be available to the user. At step 516, the routine then acquires from the user additional data that pertains to the remaining available scholarships. That is, it elicits information that is particularly relevant to the remaining available scholarships. At 518, the routine then compares this additionally acquired data with criterion from the remaining scholarships in order to eliminate yet additional, unavailable scholarships. At 522, the routine determines whether any unclassified scholarships remain. That is, it determines whether any potentially available scholarships remain that have criteria for which data has not been elicited from the user. If any such unclassified scholarships remain, then the routine proceeds back to step 516 to acquire additional information from the user pertaining to these remaining scholarships. From here, the routine proceeds as previously described. On the other hand, if no unclassified scholarships remain at step 522, then the routine proceeds to step 524. Here it determines whether any priority display scholarships exist within the compiled set of potentially available scholarships. If the remaining set of potentially available scholarships does in fact include priority display scholarships, then at step 526, the routine displays to the user the set of available scholarships with the priority display scholarships being most favorably displayed. Conversely, at step 524, if no priority display scholarships were included in the set of available scholarships, then at step 528, the routine simply displays the set of remaining available scholarships to the user.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method of providing scholarship information, comprising:
providing to scholarship searchers by a third party service provider scholarship search request forms, each scholarship search request form transmitted to a scholarship searcher being branded to a specific educational or institutional sponsor;
completing the scholarship search request form;
posting the scholarship search request form to the service provider;
searching a scholarship database in accordance with information provided by the searcher on the scholarship search request page;
returning a set of scholarships corresponding to information entered by a user; and
presenting to the searcher a description of scholarships in the set,
the third party service provider providing scholarship search request forms branded to different educational or institutional sponsors.

2. The method of claim 1 in which an institution different from the educational institution at which the scholarship will be used sponsors the scholarship search.

3. The method of claim 1 in which the scholarship search request forms are branded to an educational sponsor and to an institutional sponsor, the institution sponsor being a financial institution.

4. The method of claim 1 in which presenting to the searcher a description of scholarships in the set includes presenting a page branded to the educational sponsor or institution.

5. The method of claim 1 further comprising quantitatively rating the scholarships in the set for how closely the scholarship searcher matches the scholarship's requirements.

6. The method of claim 1 in which the set of provided scholarships includes at least one loan.

7. The method of claim 1 in which the set includes at least one grant.

8. A system for providing a scholarship searching service, comprising:
(a) multiple clients having interfaces for providing a user with access to the scholarship searching service; and
(b) a scholarship server operably accessible to the client, the scholarship server programmed to perform the acts of:
(i) presenting to the client a scholarship search form customized in accordance with the preferences of one of multiple educational institutions,
(ii) acquiring from the user initial user information, and
(iii) providing to the user a set of scholarships based on the acquired initial and additional information,
whereby the scholarship search engine provides different user interfaces branded to different institutions depending upon how the client accessed the search engine.

9. The system of claim 8, wherein the provided scholarships are each quantitatively rated for indicating how closely the user matches a scholarship's requirements.

10. The server of claim 8, wherein a second institution compensates the third party service provider for providing the customized service to the first institution as a gratuity to the first institution.
